(19) United States
(12) Patent Application Publication
(10) Pub. No.: US 2009/0132933 A1
(43) Pub. Date: May 21, 2009

(54) METHOD AND APPARATUS FOR SOCIAL NETWORKING

(76) Inventor: Jeffrey Faski, Weston, CT (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 11/941,404

(22) Filed: Nov. 16, 2007

(51) Int. Cl. G06F 3/048

(52) U.S. Cl. 715/753

(57) ABSTRACT

A method and apparatus are provided for sharing photographs among a plurality of users through a website. The method includes the steps of a first user of the plurality of users designating a human face among a plurality of human faces in a photograph displayed through the website as being the first user's face and at least some other users of the plurality of users voting through the website on whether the designated face is that of the first user.

### FIELD OF THE INVENTION

The field of the invention relates to Internet websites and more particularly to methods of sharing images.

### BACKGROUND OF THE INVENTION

Online networking involves connecting and sharing information with other like-minded people via the Internet. For example, a social network (formed through the Internet) is a social structure made of nodes (which are generally identified as being individuals or organizations) that are tied by one or more specific types of interdependency, such as values, visions, ideas, financial exchanges, friends, kinships, dislikes, conflicts, trades, web links, disease transmission (epidemiology), or airline routes.

Social network analysis views social relationships in terms of nodes and ties. Nodes are the individual actors within the networks, and ties are the relationships between the actors. There can be many kinds of ties between the nodes. Research in a number of academic fields has shown that social networks operate on many levels, from families up to the level of nations, and play a critical role in determining the way problems are solved, organizations are run, and the degree to which individuals succeed in achieving their goals.

In its simplest form, a social network is a map of all of the relevant ties between the nodes being studied. The network can also be used to determine the social capital of individual actors. These concepts are often displayed in a social network diagram, where nodes are the points and ties are the lines.

While many people regard social networking tools as a fun diversion, they also provide a forum where people can form relationships and business contacts. Moreover, not-for-profit and social organizations have begun to realize the benefits of being involved in social networking websites, not only for the increased exposure of the organization, but also because of the financial benefits of potential contacts with like-minded users. Because of the importance of networking, a need exists for a networking website that recognizes the importance of relationships between users and geographic locations and/or public or private events.

### SUMMARY

A method and apparatus are provided for sharing photographs among a plurality of users through a website. The method includes the steps of a first user of the plurality of users designating a human face among a plurality of human faces in a photograph displayed through the website as being the first user's face and at least some other users of the plurality of users voting through the website on whether the designated face is that of the first user.

### BRIEF DESCRIPTION OF THE DRAWINGS

FIG. 1 is a block diagram of a photographic sharing website system in accordance with an illustrated embodiment of the invention;

FIG. 2 depicts a home webpage that may be used by the website system of FIG. 1;

FIG. 3 depicts an account setup webpage that may be used by the website system of FIG. 1;

FIG. 4 depicts a latest uploads webpage that may be used by the website system of FIG. 1;

FIG. 5 depicts a latest hits webpage that may be used by the website system of FIG. 1;

FIG. 6 depicts an information entry webpage for uploading photos that may be used by the website system of FIG. 1;

FIG. 7 depicts a personal webpage, portions of which may be maintained automatically by the Website system FIG. 1 and portions of which may be maintained manually by a user of the website system of FIG. 1;

FIG. 8 depicts a search webpage that may be used by the website system of FIG. 1:

FIG. 9 depicts a “Hit” selection webpage that may be used by the website system of FIG. 1;

FIG. 10 depicts an enlarged photo webpage of FIG. 9 that may be used by the website system of FIG. 1;

FIG. 11 depicts a voting webpage that may be used by the website system of FIG. 1;

FIG. 12 depicts an enlarged photo webpage of FIG. 1 that may be used by the website system of FIG. 1;

FIG. 13 is a flow chart of information flow among software processing modules of the Hit Selection processor of FIG. 1;

FIG. 14 is a flow chart of information flow among software processing modules of the Vote processor of FIG. 1;

FIG. 15 is a flow chart of information flow among software processing modules of the upload processor of FIG. 1;

FIG. 16 is a flow chart of information flow among software processing modules of the results processor of FIG. 1; and

FIG. 17 is a rankings list used by the system of FIG. 1.

### DETAILED DESCRIPTION OF AN ILLUSTRATED EMBODIMENT

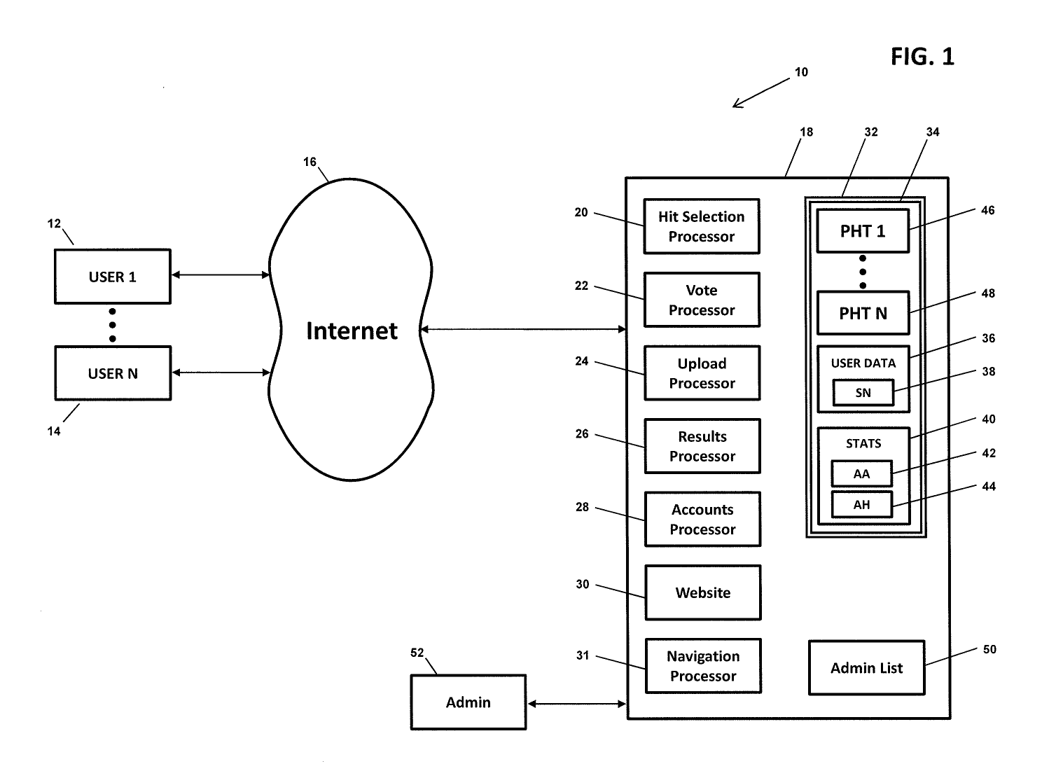

FIG. 1 depicts a photographic networking system 10 shown generally in accordance with an illustrated embodiment of the invention. The photographic networking system 10 is, in one illustrated embodiment, a social networking/activity website. In another embodiment, the photographic networking system 10 provides a resource for verifying (with peer confirmation) the presence of an individual (along with other individuals) at social, athletic, political, travel, scholastic, public or private, situations or events based upon time and/or geographic location.

Through the networking system 10, digital photos may be uploaded, tagged with information, searched, and displayed in various locations on the site (including public and personal pages). Users may review any photos they find to determine if their own human face appears somewhere in the photo among a number of other human faces. If so, they use provided tools to designate (e.g., circle) their face and add a note (e.g., text). Circles added to photos by users are tracked by the system 10 and displayed along with the photo wherever it appears. Other users may then click on the designated face and vote Yes or No (Not) as to whether a face that is circled in the photo is actually the face of the user who circled it. This is facilitated by comparing the circled face to a reference, biographical photo of the circled user.

In overview, the user may access the system 10 and receive a home page that allows a user to access at least some of the functionality of the website. Users create personalized user accounts to gain additional functionality not available to users without accounts.

Users with accounts may upload digital photographs to the site and associate distinguishing/searchable criteria with each photo. The searchable criteria may include photo title, theme, keywords, date photo taken, time photo taken, city where taken, country where taken, and other fields for general photo location details.

Users may manually navigate through a displayed list of most recently uploaded photographs. Users may also search photos based on user defined criteria.

The system 10 may return a set of photographs to the user that match the search criteria. The user may review the photographs to see if their face (or a distinguishing characteristic) appears in any photos uploaded by other users.

If a user should find a photograph that they believe contains their image (i.e., their face), they can circle their face directly on the photo. The system allows a user to manipulate the photo view to obtain the best view with provided tools. Personalized user notes may also be associated with the circle and any circles/notes added by users will appear with that photo in various locations throughout the site.

The system displays uploaded and circled photos in various locations on the site based upon the latest available or the most active by date/time of a given type (Latest Hits, Latest Uploads, etc.). The users may access the photos using a number of specialized tools and take specific actions, such as: searching, viewing, circling, voting, and adding comments.

Users may access personalized web pages (the “My FitC” web pages of other users or their own), where uploaded and circled photos associated with a particular user account may be viewed. The user may view the photos and take any of a number of actions taken such as circling and voting.

Circled photos may be visually compared side-by-side with a biographical photo associated with the user who added the circle to the photo (i.e., the “Hit” or “Hit Circle”). Other users may vote “Yes” or “No” as to whether photos that have been circled actually depict that user adding the Hit Circle.

The system tracks specific data on how many photos have been circled by individuals and by a conglomeration of users and use this data for ranking purposes. “Yes” and “No” votes by users on circled photos are also tracked and used in determining individual user success ranking, using a simple majority of “Yes” or “No” votes to assign credit for a particular “Hit”.

Users may add personal comments to their own and to the uploaded photos of other users. Photos may be marked as inappropriate by users where necessary.

Users may comment/chat with other users in a delayed response discussion environment. The comments/chat are associated with specific photos and may also may be segregated into chat rooms based upon particular web pages/photos or web pages.

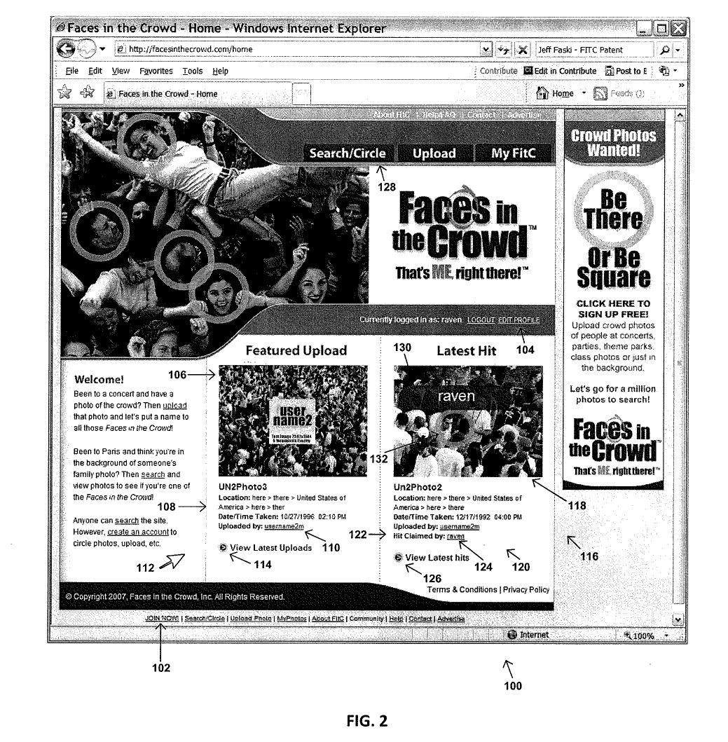

Turning now to FIG. 1, users 12, 14 may access the system 10 via the Internet 16. The users may access a browser on a personal computer 12, 14 connected to the Internet and enter a URL (e.g., “facesinthecrowd.com”, etc.) of a website 30 provided within a host 18 of the system 10. In response, the user 12, 14 may receive a home webpage 100, such as that shown in FIG. 2.

Included within the home page 100 may be a hotlink to the latest uploaded photos as well as the latest hits (i.e., the latest photo in which a user has found his image within the photo). Also included within the home page 100 may be a JOIN NOW soft key 102 and a LOGIN soft key.

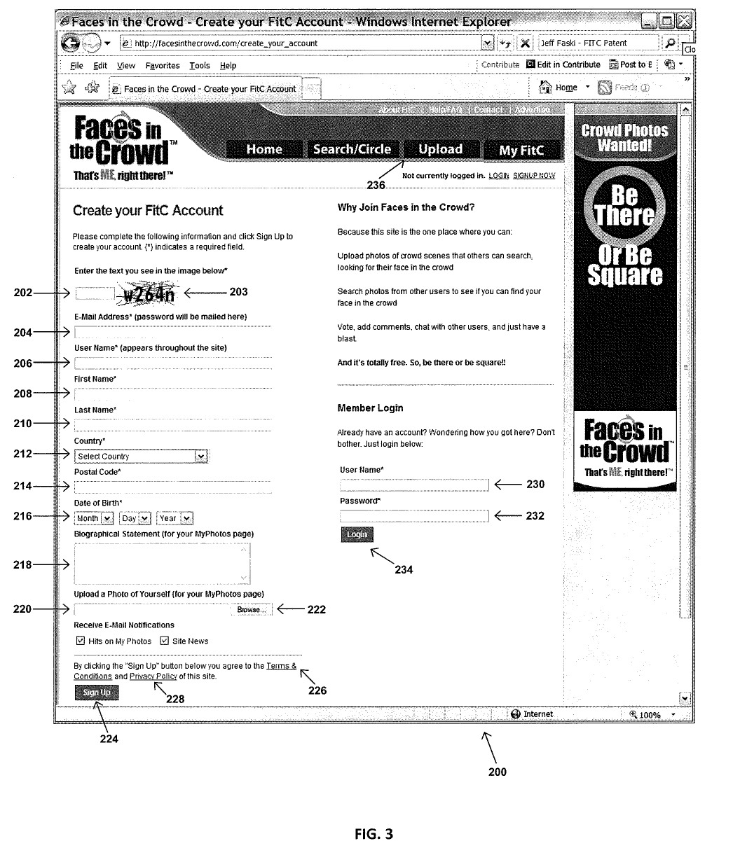

If the user should activate the JOIN NOW soft key 102, then an account processor 28 within the website 30 may download an account setup page 200, such as that shown in FIG. 3. The account setup page 200 requests selected personal information, login information, and allows for a biographical statement and a personal photo to be uploaded and associated with the user.

Included on the account setup page 200 may be an authentication window 202 where the user is requested to enter an alphanumeric sequence shown in a verification graphic 203. The verification graphic 203 contains a randomly generated alphanumeric sequence that can be read and entered by the user to verify the user is a human and not a spamming device.

The account setup page 200 may also provide an interactive box 204 for entry of an e-mail address of the user. The e-mail address is used by the system to return a password to the user and for other purposes described below.

The account setup page 200 may also provide an interactive box 206 for a screen name. The screen name will be chosen at random by the user. The system 10 will verify that nobody else has chosen the same screen name before accepting the screen name chosen by the user.

The account processor 28 may also provide boxes 208, 210 where the user may enter a first and last name. In addition, the user will be required to select a country of residence in a first box 212 and to enter his postal code in a second box 214. Another set of boxes 216 may be provided for the use to enter his date of birth. The geographic information and age of the user may be used aggregate users by geographic area or age or may be used for targeted advertising.

The user may also enter a statement of personal information in a biographic statement window 218 and to select a photo of the user within a personal photo box 220. The personal information may be a biography of the person or of the person's interests or hobbies or tastes. The digital photo may be in any form so long as the person's face is clearly shown. A browse soft key 222 is provided so that the user can locate a photograph on his own computer 12, 14 to upload to the system 10.

Once the person has finished entering information, the user may activate a SIGN UP soft key 224. In this regard, the user is notified that by clicking the Sign Up button 224 they agree to the Terms and Conditions and Privacy Policy of the site. A link 226, 228 is provided to each of those pages for review of the Terms and Conditions and the Privacy Policy.

Upon activating the SIGN UP soft key 224, the information entered by the user is sent to the accounts processor 28 where the information is processed. The user will receive a warning if the account exists, if the user name is taken, or if fields have not been completed. If one or more of these conditions exist, then the user may be given an opportunity to clarify or enter additional or different information. Upon successful submission, the system sets up an account by opening a file 34 for the user in the database 32 and enables a number of privileges related to account holders. The file 34 includes the user data 36, including the screen name 38.

The system 10 sends a confirmation e-mail to the e-mail address provided by the user 12, 14, including an auto-generated password to access the system 10, and the chosen user name. The password may be changed later in the user's Edit Profile page.

By setting up an account, a user 12, 14 is allowed to upload photos, circle their face in photos, add notes to that circle, vote on other user's circled photos, and add comments to photos and pages on the site. For users without accounts, or those not logged in, any functions requiring an account will take users to a login page (e.g., create an account webpage 200) with fields 230, 232 for entering login information as well as soft keys to Sign Up Now and retrieve lost login information. The user may sign up or, if he/she already has an account they may enter a user name in a first field 230, their password in a second field 232 and activate the LOGIN soft key 234.

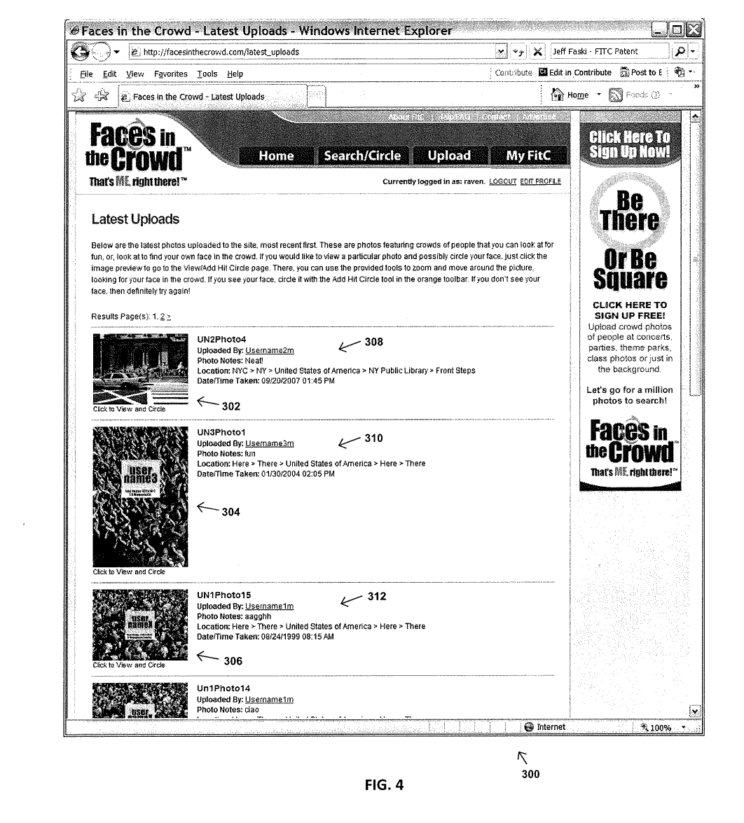

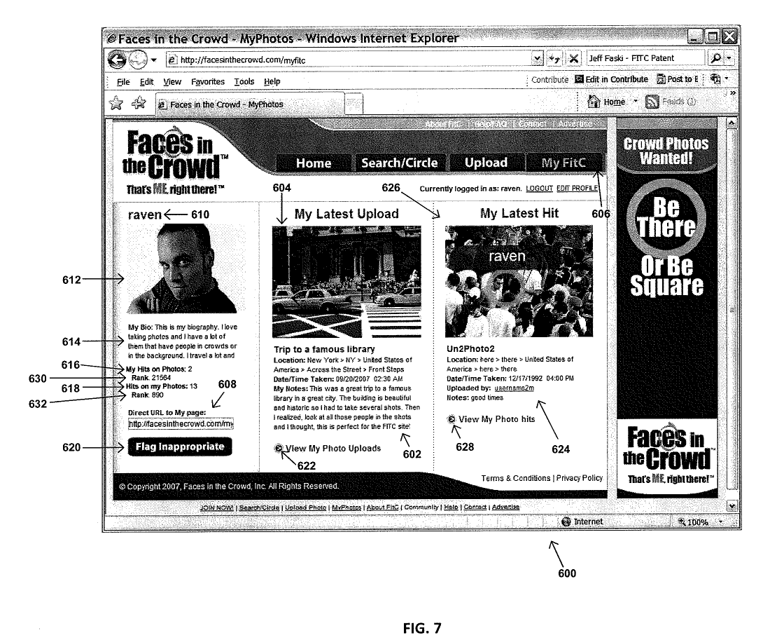

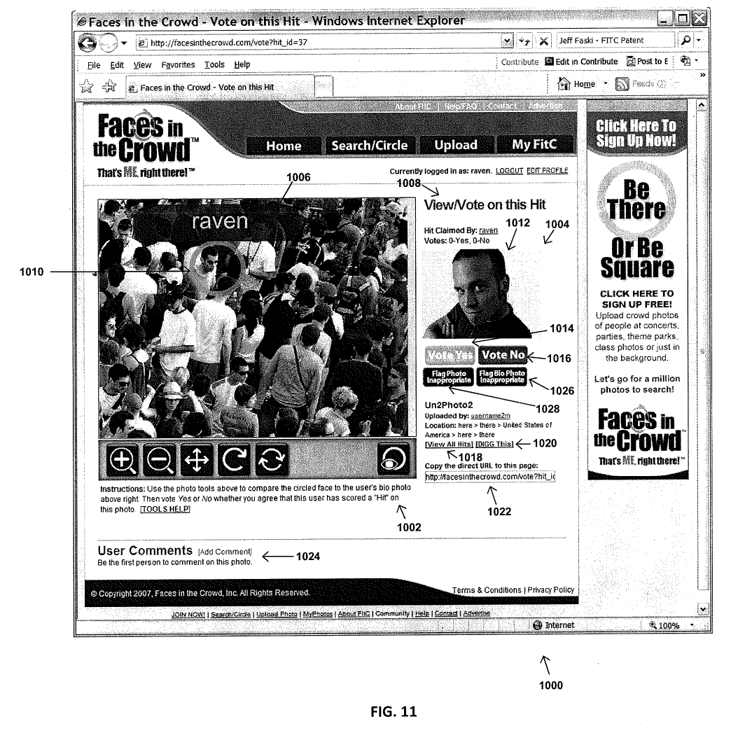

The user's unique screen name 38 appears wherever that user has taken action on the site, such as next to their uploaded photos on the Latest Uploads page (FIG. 4)., or along with a “Hit Circle” they added to a photo via a View/Add Hit Circle page (FIG. 11). The username is clickable to access that particular user's personal My FitC page (FIG. 7).

The user's account 34 is also populated with statistics within a statistics file 40 on how many successful “Hit Circles” 42 the user has added to photos as well as how many “Hit Circles” 44 have been added to photos the user has uploaded.

Account information 36 may be edited by the user at any time by clicking the Edit Profile link 104 provided on every page when that user is logged in.

The Edit My Profile page is nearly identical in function and content to the Account Setup page 200. The differences are that it pre-populates the form with the user's existing account information, enables the user to choose additional bio photos, and provides a link to an Edit My Photo Uploads page (not shown) where users may manage (edit, replace, delete) the photos they have uploaded and saved in files 46, 48.

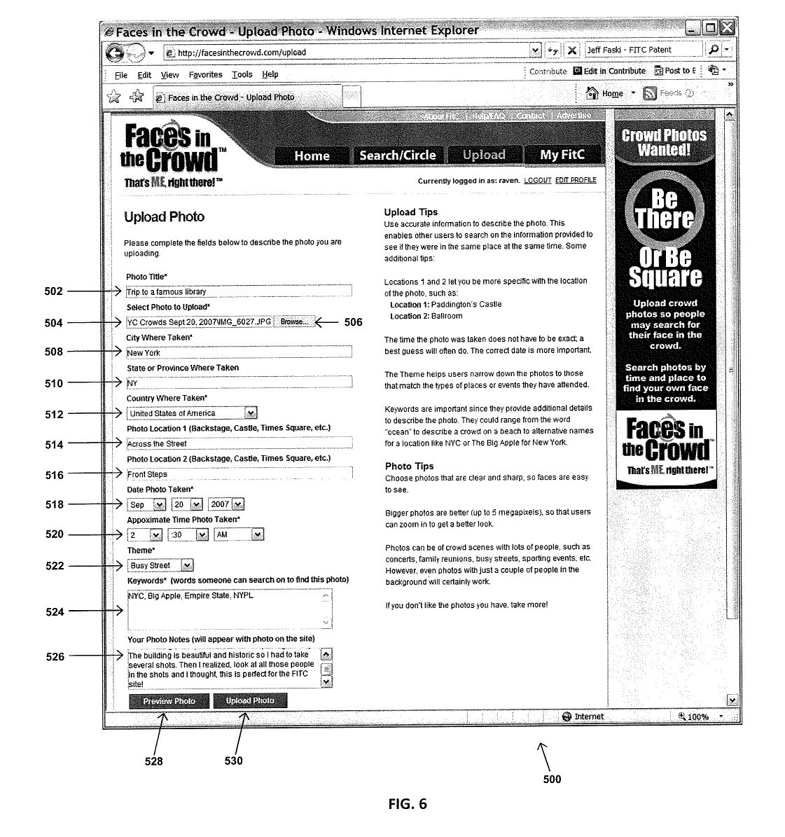

A link in a user's Edit My Profile page takes users to the Edit My Photo Uploads page (nearly identical to the Latest Uploads page 300 (FIG. 4)) where a user's particular uploaded photos are listed along with previews and information related to each photo. The difference is that the photos are related to a particular user's account 34 and each photo also has an Edit and Delete function link (soft key) associated with it. The Edit link displays the Edit Photo form (nearly identical to the Photo Upload page 500 (FIG. 6)), that is pre-populated with a particular photo's information as well as options to change that information or replace the photo 46, 48.

Returning now to the home page 100, the home page displays a preview 130 of the featured uploaded photo 106, automatically reduced in size, chosen manually by an Administrator of the system 10, and called the Featured Upload.

Beneath the Featured Upload is displayed the photo's details 108 as specified by the photo's uploader/user 12, 14, including fields for: Photo Title, Location, Date/Time Taken, and Uploaded By (with a link 110 to that user's My FitC page (600 (FIG. 7)). The “Uploaded By” field shows the user's screen name 38.

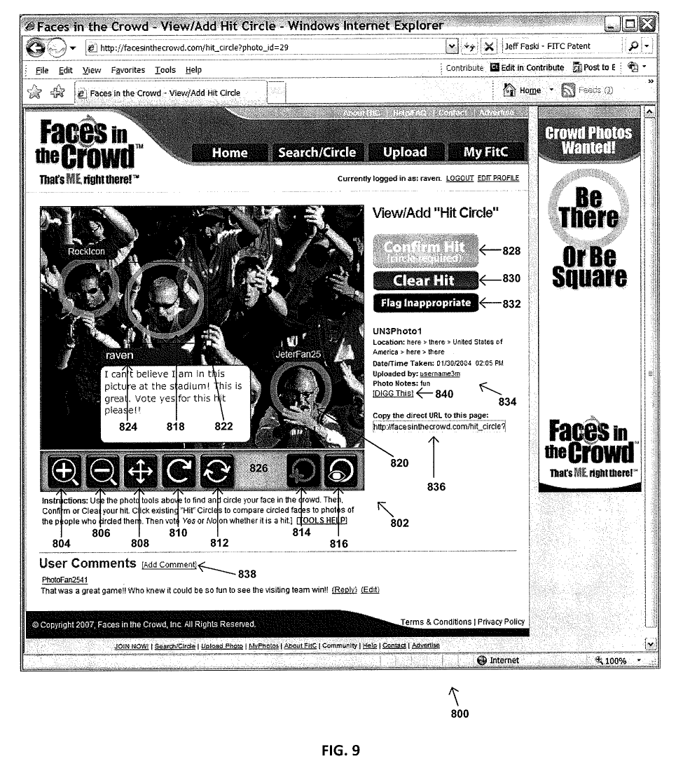

When the user places a cursor 112 over and activates a switch on the user's mouse (i.e., clicks on) the Latest Upload preview image 106, or the photo title, a navigation processor 31 takes a logged in user to the Review/Add Hit Circle page 800 (FIG. 9) for that photo 106.

The home page 100 also displays a preview 116 of the photo 118 with the latest Hit Circle 132 added to a photo 118. In this case, preview 116 shows the photo 118 automatically reduced in size. The photo 118 is chosen automatically by the system (determined by date and time of the Hit it contains).

Beneath the photo 118 are displayed the photo's details 120 as specified by the photo's uploader/user, including fields for: Photo Title, Location, Date/Time Taken, and Uploaded By (with a link to that user's My FitC page). Also displayed is a Hit Claimed By field 122 (showing the screen name 38 of the person who added the Hit Circle 132 to the photo) along with a link 124 to that person's My FitC page 600.

The Latest Hit preview image 116 also stores all zoom and positioning information for the Hit Circle (defined when the circle was added on the View/Add “Hit Circle” page 800 (FIG. 9)), so that the human face of the specific hit is emphasized. The zoom and positioning information may include a window size and an x-y location on the photo 46, 48 that is intended to be centered in the window. Also included is a size and position of the circle that defines the hit and placed around the person's face.

When the user 12, 14 clicks on the Featured Hit preview image 118, or the photo title, on the home page 100, a logged in user 12, 14 is taken to the View/Vote on this Hit page 1000 (FIG. 11) for that photo. The View/Vote page 1000 is discussed in more detail below.

Beneath the Featured Upload photo preview 106 on the home page 100, a link 114 is provided to View Latest Uploads. This link 114 takes the visitor 12, 14 to the Latest Uploads page 300 (FIG. 4), featuring a list of uploaded photos 302, 304, 406 (most recently uploaded first), uploaded by various of the members 12, 14 of the site 30 (limited to the latest 100 uploads).

A preview image of each photo 302, 304, 306 is provided and next to it are displayed the photo's details 308, 310, 312 as specified by the photo's uploader/user 12, 14, including fields for: Photo Title, Uploaded By (with a link to that user's My FitC page), Photo Notes, Location, Date/Time Taken, and Theme. If a user 12, 14 clicks on any of the Latest Uploads photo previews 302, 304, 306, or the photo's title, a logged-in user is taken to the Review/Add “Hit Circle” page 800 (FIG. 9) for that photo.

The list of photos on the webpage 300 is limited to the latest 100 uploads to the site 30. The photos 302, 304, 306 may be chosen automatically by an upload processor 24 based upon date and time of the upload.

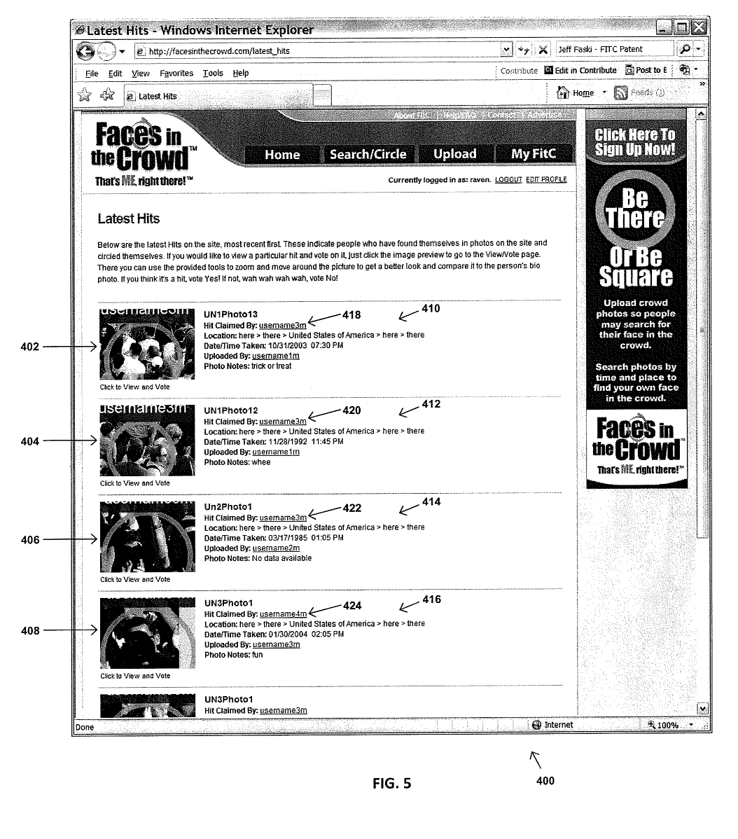

Beneath the Latest Hit photo preview 116 on the home page 100, a link 126 is provided to View Latest Hits. This link 126 takes the visitor to the Latest Hits page 400 (FIG. 5), featuring a list of photos with Hit Circles (most recent Hits first), circled by members 12, 14 of the site 30 (limited to the latest 100 Hits). A Latest Hit preview image 402, 404, 406, 408 of each photo 46, 48 with a Hit Circle is provided and next to it are the photo's details 410, 412, 414, 416 as specified by the photo's uploader/user 12, 14, including fields for: Photo Title, Location, Date/Time Taken, and Uploaded By (with a link to that user's My FitC page 600). Also displayed is Hit Claimed By (identifying the person who added the Hit Circle) along with a link 418, 420, 422, 424 to that person's My FitC page 600.

As noted above, the Latest Hit preview image 402, 404, 406, 408 also includes zoom and positioning information for the Hit Circle, added to the photo 402, 404, 406, 408 using tools 802 on the View/Add Hit Circle page 800, so that the specific hit is emphasized.

If a user should click on any of the Latest Hit photo's preview image 402, 404, 406, 408, or the photo's title, the logged-in user 12, 14 is taken to the View/Vote on this Hit page 1000 (FIG. 11) for that photo 402, 404, 406. The list on the Latest Hit webpage 400 is limited to the 100 latest circled hits on photos 402, 404, 406, automatically chosen by the hit selection processor 20 based upon the date and time of the hit.

From time to time, a user 12, 14 may choose to upload photos to the site 30. The digital photo may include people in a crowd, in the background, etc. They may intend that this photo to be available to other users on the site 30, to search for, to review, and for those other users to add a hit circle to their own face if they find it in the photo.

In this case, the logged-in user 12, 14 accesses an upload processor 24 on the site 30 and receives the Upload Photo page 500 (FIG. 6). The webpage 500 may contain fields for uploading the photo and for entering information to distinguish that photo from other photo for purposes of searching or display.

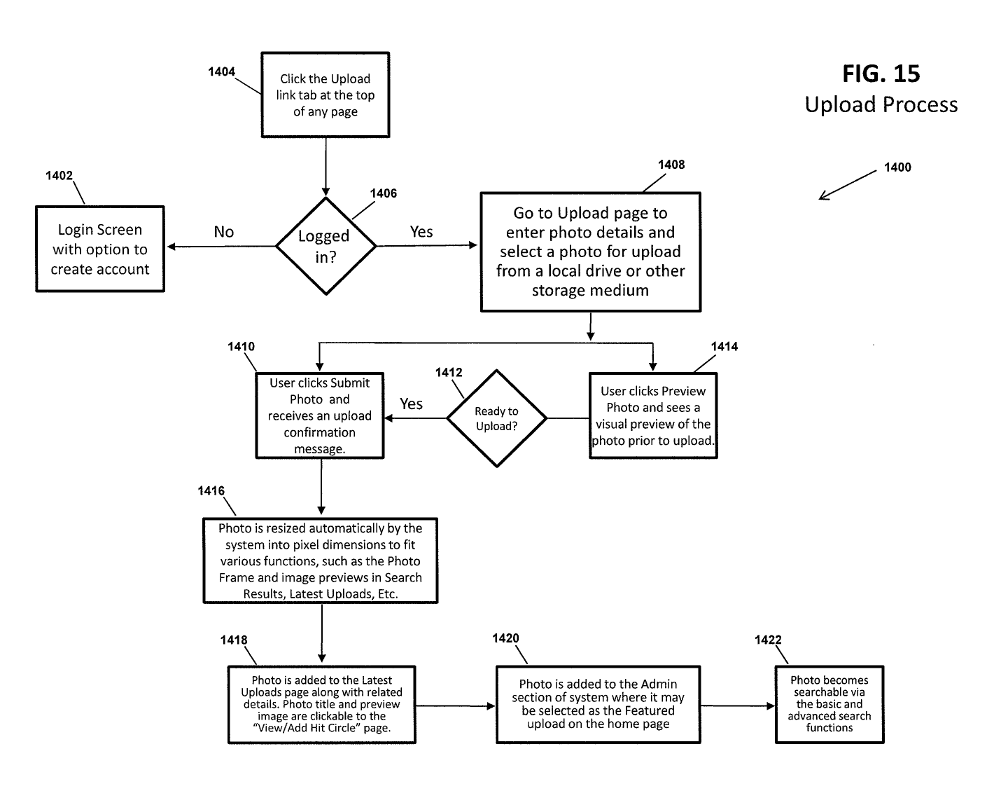

FIG. 15 depicts a flow chart 1400 of the process performed by the upload processor 24. It should be noted in this regard that even though FIG. 15 is presented in the form of a flow chart the various boxes of FIG. 15 are also used to depict the software, subroutines, or software modules used to accomplish the steps of the upload process.

A user 12, 14 may access the webpage 500 by clicking (activating the program module) 1404 on the Upload link at the top of any page 1404 or by clicking (activating the program) 1406 from the Login screen with option to create account. The upload processor 24 first determines whether the user 12, 14 is logged in 1406. If so, then the user 12, 14 is taken 1408 to the upload page 500

The user 12, 14 may enter a path identifier into a photo identifier field 504 or activate a browse soft key 506 to look for a photo on the user's computer 12, 14. The user 12, 14 may choose the digital photo from their local computer's hard drive or from another device with Internet capabilities, such as a cell phone, smart phone, iPod, iPhone, or PDA. Once the user 12, 14 finds the photo, the user 12, 14 may enter a title within a title field 502. The user 12, 14 may also enter a city where the photo was taken within a city field 508, a state or province within a state or province field 510 and a country where taken within a country field 512. The user 12, 14 may also identify a geographic location of the photo within a first photo location field 514, a location from where the photo was taken within a second photo location field 516 and a date and time of the photo within a date field 518 and time field 520. Within the time and date fields 518, 520 pull-down menus may be provided.

The user 12, 14 may define an overall context of the photo within a theme field 522. The theme may identify a location or event (e.g., travel, theme Park, family event, military event, parade, concert, sporting event, busy street, park, beach, etc.).

The user may also provide keywords associated with the photo within a keywords field 524. In order to further describe the photo, a photo notes field 526 is provided where the user can enter his thoughts or impressions of the photo.

Once the required fields are completed, the user has the option to preview the photo before uploading to the system. In this regard, the user may activate a preview photo soft key 528 and, in response, a preview module 1414 may present the user 12, 14 with a view of the photo and associated information as it would appear on the website 30.

If the user is not ready to upload the photo, the user may continue to modify the photo and associated field until the user is ready 1412 to upload the photo. Once the required fields are completed, the user has the option to submit the photo to the system. Once the user is ready 1412 to upload the photo and associated information, the user activates an upload module 1410 by activating an Upload Photo soft key 530.

Once a photo is submitted/uploaded, a photo processing module 1416 within the upload processor 24 of the system 10 generates an Image Upload Confirmation Page for each successful upload. The Image Upload Confirmation Page is downloaded and displayed on the user's 12, 14 computer. If the photo is not successfully uploaded, the processor 24 generates descriptive error messages so the user may make adjustments and try submitting again.

An operative portion 1418 of the upload processor 24 adds the photo as a photographic file 46, 48 to the database 32 and to the latest uploads page. The upload processor 24 may resize the photo automatically to meet maximize pixel size requirements of the site (e.g., 5 megapixels). The processor 24 may also start tracking site activity related to that image. Another portion 1422 of the uploads processor 24 adds the links so that the photo becomes searchable.

Another operative portion 1420 of the upload processor may add the photo to administrator's Active Photos List 50 where it may be assigned by an admin for access through the home page 100. The upload processor 24 may also add the photo as a photographic file 46, 48 to the users account file 32 where the photos become available for display on the user's My FitC page 600 under the My Latest Upload area 602. Here another user 12, 14 may click on the photo preview 604 and a hit selection processor 20 may detect the click from the other user and provide the other user with a View/Add “Hit Circle” page 800.

The upload processor 24 makes the photo available on the user's My Uploads page where it is shown with a preview thumbnail image and relevant descriptive data. Depending on selections by other users 12, 14, the photo is clickable to a specific action page (e.g., the View/Add Hit Circle page 800).

The uploaded photos from users 12, 14 remain within the Administrator's list 50 of the site 30 for a time period during which the photo may be selected for the Featured Upload preview area 130 on the site's home page 100. The photo may also be searched for, deactivated, edited or deleted from the admin list 50 by the administrator working through an administrator's terminal 52.

Uploaded photos, and their related information, may be modified by the users who uploaded them at any time (while those users are logged in). This is done by clicking the Edit My Photo Uploads link on a user's Edit Profile page.

In general, each registered user gets their own My FitC page 600 which features the owning user's provided biographical information as well as their activity on the site. An owning user may reach his/her own My FitC page 600 at any time by clicking the My FitC tab 606 at the top of all pages, while logged in. Other users may also access the owning user's My FitC page by using the provided “Direct URL to My Page” 608, or, by clicking the owning user's screen name where it appears throughout the site.

Each My FitC page 600 includes the owning user's user name 610. The My FitC page 600 also includes the Bio Photo 612. The personal bio photo 612 is uploaded by the owning user 12, 14 and is used by other users 12, 14 for comparison when the other users vote on the Hit Circles. The My FitC page 600 also displays the bio 614 previously entered through the bio window 218.

The My FitC page 600 also includes statistics on the owning user's success (both actual and relative) in recognizing his own face in other user's photos and other user's recognition of their faces in the owning user's photos. A My Hits window 616 indicates the number of Hit Circles the owning user has placed on other people's images, and the owning user's resulting ranking 630 in this category on the site (rankings determined by the number of Hit Circles on other user's images and a simple majority of Yes votes provided by other users to validate each Hit).

Also included on the My FitC page 600 is a Hits on My FitC window 618. The Hits on My FitC window 618 indicates the number of hits other users have found on the owning user's images, and the owning user's resulting ranking 632 in this category on the site (rankings determined by the number of Hit Circles other users have added to the owning user's photos and a simple majority of Yes votes provided by other users to validate each Hit).

The My FitC page 600 also includes a Direct URL to My Page 608. The direct URL to the user's page can be copied and shared with other users.

The My FitC page 600 also includes a “Flag as Inappropriate” softkey 620. The Flag as Inappropriate button 620 may be used by a user to flag another user's bio photo 612 for inappropriate content. Each person may flag a particular bio photo 612 only once. When multiple people have flagged the same photo, it is made inactive and replaced by a placeholder image. When a flag is confirmed, the user whose photo was flagged is notified automatically via e-mail.

The My FitC page 600 also includes a preview of a user's latest uploaded photo 604, automatically reduced in size, chosen automatically by the system (determined by date and time of upload), and called My Latest Upload. Beneath the My Latest Upload 604 are displayed the photo's details as specified by the photo's uploader/user 12, 14, including fields for: Photo Title, Location, Date/Time Taken, and My Notes.

Clicking on the My Latest Upload preview image 604, or the photo title, takes a logged in user to the View/Add Hit Circle page 800 for that photo. Beneath the My Latest Upload photo preview 602 on the My FitC page 600, a link 622 is provided to View My Photo Uploads. This link 622 takes the visitor to the My Photo Uploads page, featuring a list of the owning user's uploaded photos (most recent uploads first by date and time). The function and appearance of the My Photo Uploads page is nearly identical to the site's overall Latest Uploads page 300. The difference is that the My Photo Uploads page shows the photo uploads only for a specific user. And, it is only accessed from a user's personal My FitC page.

A preview 624 of a user's latest Hit Circle shown on a photo, automatically reduced in size, chosen automatically by the system (determined by date and time), and called My Latest Hit is shown on the My FitC page 600. Beneath the preview 624 is displayed the photo's details 626 as specified by the photo's uploader/user, including fields for: Photo Title, Location, Date/Time Taken, and Uploaded By (with a link to that user's My FitC page), and Notes by the uploader. The Latest Hit preview image 624 also contains metadata including zoom and positioning information for the Hit Circle (defined when the circle was added on the View/Add “Hit Circle” page), so that the specific hit is emphasized.

Clicking the My Latest Hit preview image 624, or the photo title, on the My FitC page 100 takes a logged in user to the View/Vote on this Hit page 1000 (FIG. 11) for that photo. Beneath the My Latest Hit photo preview 624 on the My FitC page 600, a link 628 is provided to View My Photo Hits. This link 628 takes the visitor to the My Photo Hits page, featuring a list of this user's Hit Circles (most recent Hit first by date and time). The function and appearance of the My Photo Hits pages is nearly identical to the site's overall Latest Hits page 400. The difference is that the My Photo Hits page shows the photo Hits only for a specific user. And, it is only accessed from a user's personal My FitC page.

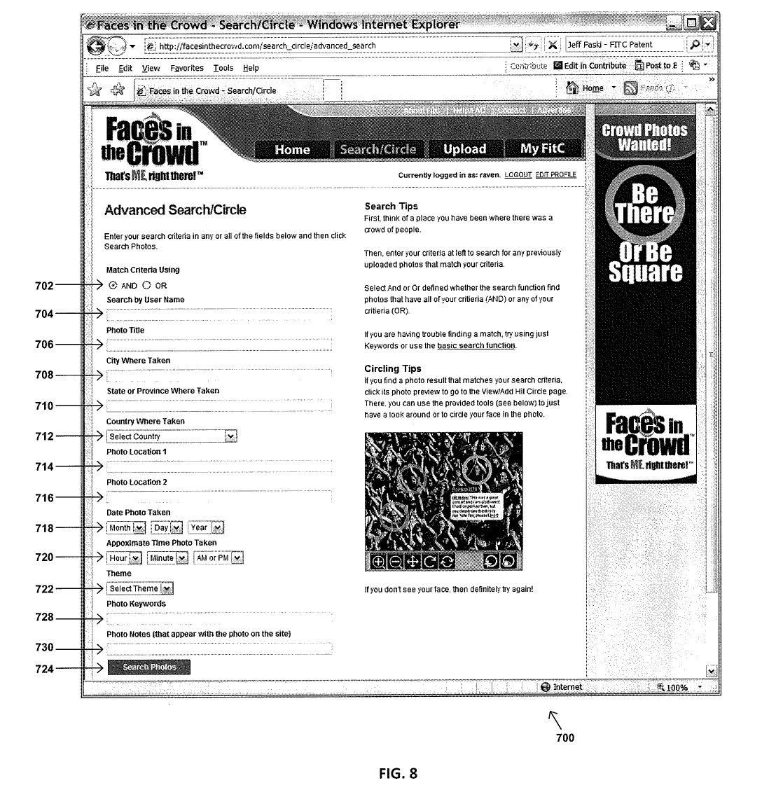

The Advanced Search Page 700 (FIG. 8) (for users with or without accounts) will be considered next. A user who wants to search for photos that they might be interested in, or just to browse, clicks the Search/Circle navigation tab 128 to access search functions. The link takes them to the basic search page (not shown) which has a single keyword field for searching ALL fields related to information provided by a photo's uploader.

If the user chooses advanced search, the Advanced Search/Circle form 700, is displayed with fields for selecting or entering distinguishing criteria (based on fields from the photo upload form) to narrow the search to those photos meeting that particular user's criteria. Search criteria includes: 1) Match Criteria Using AND or OR 702; 2) Search by User Name 704; 3) Photo Title 706; 4) City Where Photo Taken 708; 5) State or Province Where Photo Taken 710; 6) Country Where Photo Taken 712; 7) Photo Location 1 714; 8) Photo Location 2 716; 9) Date Photo Taken with Pull-downs for Month, Day, Year 718; 10) Approximate Time Photo Taken with Pull-downs for Hour, Minute, AM/PM 720; 11) Theme of Photo 722 where the theme may include: a) Travel; b) Theme Park; c) Family; d) Military; e) Parade; f) Concert; g) Sporting Event; h) Busy Street; i) Park, j) Beach or k) Other; 12) Photo Keywords or 13) Photo Notes (that appear with the photo on the site). A user may also enter searchable photo keywords in a Photo Keywords window 729 or searchable notes keywords in a Photo Notes window 730. A User enters one or more search criteria and clicks the “Search Photos” button 724. Any photos matching the user's criteria are displayed in a list format, limited to the closest 100 results. Photo search results have clickable thumbnails and titles that will take users to the View/Add Hit Circle page when clicked. The function and appearance of the Search Results page is nearly identical to the site's overall Latest Uploads page. The difference is that the Search Results web page is generated on the fly based on provided search criteria.

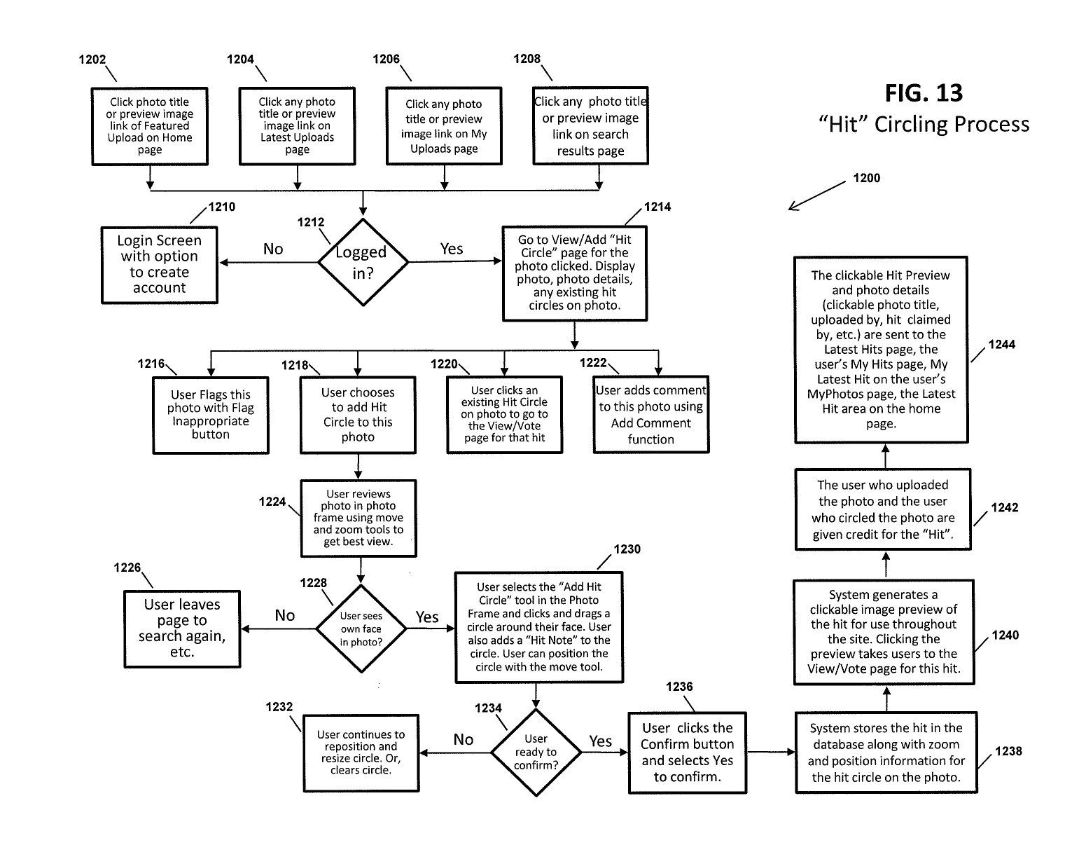

The View/Add “Hit Circle” page 800 (FIG. 9) (for users with accounts who are logged in) will be considered next. FIG. 13 depicts a flow chart 1200 of the process performed by the Hit Selection processor 20. It should be noted in this regard that even though FIG. 13 is presented in the form of a flow chart, the various boxes of FIG. 13 are also used to depict the software, subroutines, or software modules used to accomplish the steps of the upload process.

In those instances where a photo is viewed (and available to be circled), links 1202, 1204, 1206, 1208 are provided that will take a logged-in user to the View/Add “Hit Circle” page 800 for that photo when the photo or its title is clicked. These links take the form of clickable photo preview images or clickable photo titles, such as: 1) The Featured Upload on the home page, 2) Results listings on the Latest Uploads page, 3) My Latest Upload on a user's My FitC page, 4) Results listings on a user's My Photo Uploads page or 5) Search results.

A first portion 1212 of the Hit Selection processor 20 checks to see if the user 12, 14 is logged in. If not, another portion 1210 of the Hit Selection processor 20 takes the user to Login Screen with option to create account 200.

If the user is logged, another portion 1214 of the Hit Selection processor 20 takes the user 12, 14 to the View/Add “Hit Circle” screen 800. Upon reaching the View/Add “Hit Circle” page 800 for a particular photo, a user sees the photo they selected to review (by clicking its preview or title) along with any other “Hit Circles” added to it previously by other users.

The user 12, 14 may choose to add 1218 a Hit Circle to this photo. Using the provided tools 804, 806, 808, 810, 812, 814, 816 in the “Hit” Photo Frame 802, users may use a photo manipulation portion 1224 of the Hit Selection processor 20 to view the photo in various positions to better determine if their own face appears 128 within it. Users can zoom in and out on the photo using the Zoom tools (plus and minus) 804, 806. Users can move a photo within the window with the Move tool 808. Users can rotate the image in 90 degree increments using the Rotate tool 810. Users can reset the image using the Reset tool 812. At any time, the user 12, 14 may leave 1226 the page.

Users can activate a Hit Circle add portion 1230 of the Hit Selection processor 20 to add a “Hit Circle” to the photo using the Hit circle tool 814 by clicking on the image of the tool 814. The circle 818 is 100% opaque orange when they add it. Any other existing circles 820 shown are 75% opaque.

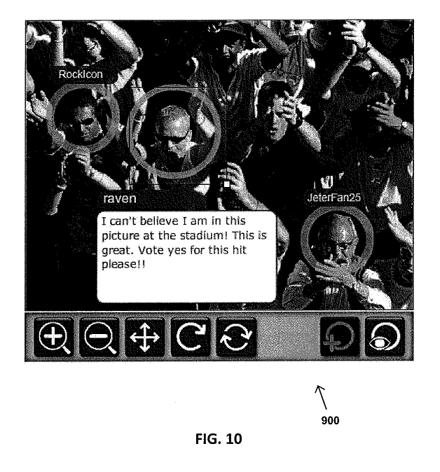

User can resize their Hit Circle 818 as needed by clicking and dragging the resizing square 822 in the lower right of the circle. The hit selection processor 20 within the System 10 remembers the zoom size and positioning of the image 900 (FIG. 10) when the Hit Circle was added by the member 12, 14 in the “Hit” Photo Frame 802. When the user adds the circle 818, their user name 824 appears below the circle 818 with a text window so they may add a Hit Note 826. The user name 824 appears above the circle and the Hit Note 826 (when rolled over) appears below the circle 818 after the Hit Circle 818 is confirmed via activation of a Confirm Hit button 828.

Users can also show/hide the circles using the Show/Hide tool 816.

If upon reviewing the photo, the user 12, 14 finds what they believe is their own face, distinguishing feature, etc., the user may use the Add Hit Circle tool 814 to click and drag a Hit Circle 818 of the correct size around their face and type a personal Hit Note 826. The move tool 808 can be used to position the circle 818 and its Hit Note. The user 12, 14 may continue to manipulate 1232 the photo until they are convinced of their own presence within the photo.

Once the user is ready to confirm 1234, the user may then Confirm the Hit Circle by activating 1236 the Confirm Hit button 828, which becomes active when a Hit Circle 818 is added within the Photo Frame 802. Once confirmed, a Hit processing portion 1238 of the hit selection processor 20 adds a number of data items to the photo file 46, 48. Another portion 1240 of the Hit Selection processor 20 generates a clickable image for use throughout the site. For example, the hit selection processor 20 associates the Hit Circle 818 and Hit Note 826 with the photo. Both are then visible to whomever views that photo 802, along with any other hit circles 820 on that photo 802. In addition, the “Hit Circle” and “Hit Note” added to the photo are associated by the hit selection processor 20 with the circling user's account 32. A user credit portion 1242 of the hit selection processor 20 saves an identifier of who added a particular hit circle to the photo 46, 48 and also displays their user name above the Hit Circle 818 in the “Hit” Photo Frame 802.

A hits processing portion 1244 of the Hit Selection processor 20 creates the link to associate the Hit with the image where it appears throughout the website. The image is listed by the hit selection processor 20 in the user's My Latest Hit preview area 624 on the circling user's My FitC page 600 and on their My Photo Hits page. The hit selection processor 20 adds the photo (along with the Hit Circle) to the home page 100, if it is currently the Latest Hit (by date and time of Hit) and to the top of the listings on the Latest Hits page if it is currently the latest hit, determined by date and time of the hit relative to other hits.

The hit selection processor 20 also adds the user's name 610 to the “Hit Claimed By” field associated with that particular hit on the photo. In this case, the User name is clickable.

The hit selection processor 20 sends notification to the person who uploaded the photo that someone add a “Hit” on their photo, with a link to the “View/Vote for this Hit” page for that photo. The user who originally uploaded the photo is also given credit by the hit selection processor 20 for this user's “Hit” on the photo they have uploaded.

The User 12, 14 may clear the Hit Circle 818 at any time by using the Clear Hit button 830. The Clear hit button 830 becomes active when a Hit Circle is added within the “Hit” Photo Frame 802.

Users 12, 14 may click on existing “Hit Circles” 820 on photos to access “View/Vote on this Hit” pages 800 associated with each circle and another portion 1220 of the Hits Selection processor 20 will take the user 12, 14 to another photo. Rolling the cursor 112 over any Hit Circle 820 makes the semi-transparent circle 100% opaque and shows the user's “Hit Note” 826 for that circle 818.

The user may also click on the User Name bar 824 above a Hit Circle 818. In this case the hit selection processor 20 takes the user to that user's My FitC page 600.

On the View/Add “Hit Circle” page 800, information 834 related to the photo is also displayed as specified originally by the photo's uploader/user. The information 834 includes fields for: Photo Title, Location, Date/Time Taken, Uploaded By (with a link to that user's My FitC page) and Photo Notes.

A Direct URL 836 to the Page 800 is provided for visitors 12, 14. The URL 836 that can be copied and shared with other users to access the page directly.

A link or function 840 to interface with one or more community based popularity websites (e.g., DIGG, etc.) or “e-mail a friend” may also be provided. The link or function may be provided for users to submit a particular photo to said community-based popularity websites or, e-mail a link to the photo to a friend.

Users 12, 14 may also add general comments on the page 800, regarding the photo, the Hit Circles 820 already added, etc., through a comments portion 1222 of the Hits Selection processor 20 by using provided comments tools 838. Other users may reply to those comments as well.

In addition, Users 12, 14 may also flag a photo 802 or comment 826 as inappropriate to help maintain the integrity of the site through another portion 1216 of the Hits Selection processor 20 by activating an appropriate button 832 or link in the Comments 838 area. A user with flagged photos or comments is notified automatically by e-mail so that the user may remedy the item in question.

If additional flags are added to a photo or comment before that user remedies the item, the photo or comment is automatically removed from the site. When multiple photos or comments for an account 32 are flagged and removed, the account 32 is automatically de-activated as are all photos, bio photo, comments, votes related to that account 32, effectively removing all traces of that user from the site.

As noted above, other users 12, 14 can view the preview 116 of the Latest Hit on the site. Alternatively, the users 12, 14 may view any of number Hits via the Latest hits link 126.

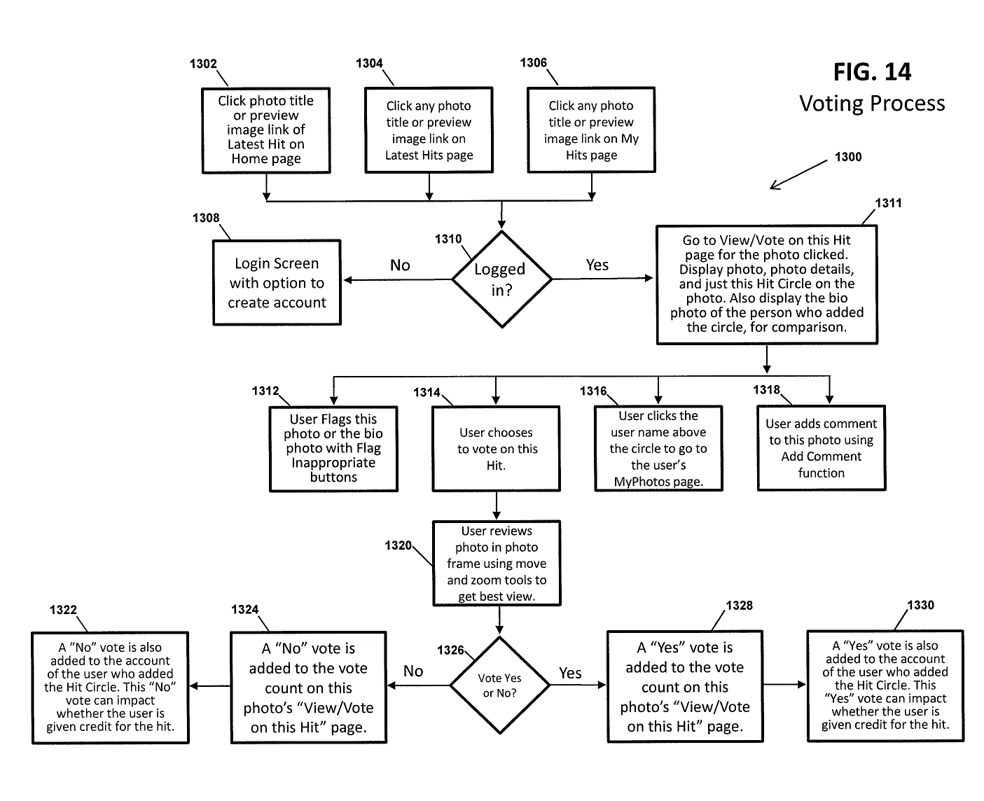

In those instances where users 12, 14 may choose to vote on an existing “Hit Circle” on a photo, a link is provided that will take a logged-in user to the “View/Vote on this Hit” page 1000 for that photo (FIG. 11) when clicked. FIG. 14 depicts a flow chart 1300 of the process performed by the Vote processor 22. It should be noted in this regard that even though FIG. 14 is presented in the form of a flow chart the various boxes of FIG. 14 are also used to depict the software, subroutines, or software modules used to accomplish the steps of the upload process.

The links 1302, 1304, 1306 to the View/Vote page 1000 take the form of clickable photo preview images, hit circles, or clickable photo titles, such as: 1) The Latest Hit on the home page; 2) Results listings on the Latest Hits page; 3) My Latest Hit on a user's My FitC page or 4) Results listings of My FitC Hits on a user's My Photo Hits page 5) Existing Hit circles on a photo.

Upon activating one of the links 1302, 1304, 1306, a first portion 1310 of the Vote processor 22 may check to see if the user 12, 14 is logged in and if not takes 1308 the user to the login screen. If the user is logged in, then the portion 1310 takes the user to the View/Vote page 1000.

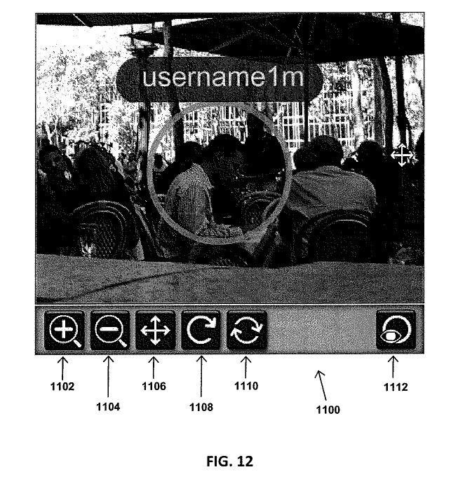

Upon reaching the “View/Vote on this Hit” page 1000 for particular photo, a view portion 1311 presents the user with the photo they selected (by clicking its preview, title, etc.) along with the one Hit Circle 1010 they have chosen to vote on. Using a presentation process 1320 and the provided tools 1102, 1104, 1106, 1108, 1110 in the “Vote” Photo Frame (FIG. 12), users may view the photo in various positions to better determine if the user claiming the Hit Circle is the person in the image. The bio photo 1012 of the user claiming the hit is provided for comparison purposes.

Users can zoom in and out on the photo using the Zoom tools (plus and minus) 1102, 1104. Users can move the photo within window with the Move tool 1106, can rotate image in 90 degree increments using the Rotate tool 1108 or can reset the image using the Reset tool 1110. Users can also show/hide the circle they are voting on using the Show/Hide tool 1112.

Upon comparing a face within the Hit Circle to the provided biographical image 1012, a user can choose 1314 to Vote “Yes” or “No” whether they agree that the circled face in the photo is the face of the person who circled it. The user confirms 1326 their vote by clicking the Vote Yes or Vote No button 1014, 1016.

When the vote is confirmed, the vote is added by a results processor 26 to the statistics 40 of the account 32 for the user who circled the photo. A first tallying portion 1328 or second tallying portion 1324 of the results processor 26 adds the resulting vote and increments the Yes Vote or No Vote tally on the “View/Vote on this Hit” page for that photo. The first tallying portion 1328 adds the vote to the “Yes” total 1330 and has a positive impact on the standing of the user who added the hit. A “No” vote may be subtracted from the total 1322.

Rolling the cursor 112 over any Hit Circle 820 makes the semi-transparent circle 100% opaque and shows the user's “Hit Note” for that circle. Clicking the User Name bar 824 above a Hit Circle 820 takes 1316 the user to that user's My FitC page 600.

On the View/Add “Hit Circle” page 800, information 834 related to the photo is also displayed as specified originally by the photo's uploader/user. This includes fields for: Photo Title, Location, Date/Time Taken, Uploaded By (with a link to that user's My FitC page) and Photo Notes.

A View All Hits function link 1018 is provided on the webpage 1000 to take a user back to the View/Add “Hit Circle” page 800 for a particular photo. A link or function 1020 to interface with one or more community based popularity websites (e.g., DIGG, etc.) or “e-mail a friend” may also be provided. The link or function may be provided for users to submit a particular photo to said community based popularity websites or e-mail the link to the photo to a friend. A Direct URL 1022 to this Page 1000 is provided that can be copied and shared with other users to access the page 1000 directly.

Users may also add general comments 1318 on the page, regarding the photo, the Hit Circle they are voting on, etc., by using provided comments tools 1024. Other users may reply to those comments as well.

Users may also flag a bio photo, an uploaded photo, or comment as inappropriate 1312 through an appropriate set of buttons 1026, 1028, or link in Comments area 1024, to help maintain the integrity of the site. A user with flagged photos or comments is notified automatically by e-mail so that user may remedy the item in question. If additional flags are added to a photo or comment before the user remedies the item, the photo is automatically removed from the site. When multiple photos or comments for an account are flagged and removed, the account is automatically de-activated as are all photos, bio photo, comments, votes related to that account 32, effectively removing all traces of that user from the site.

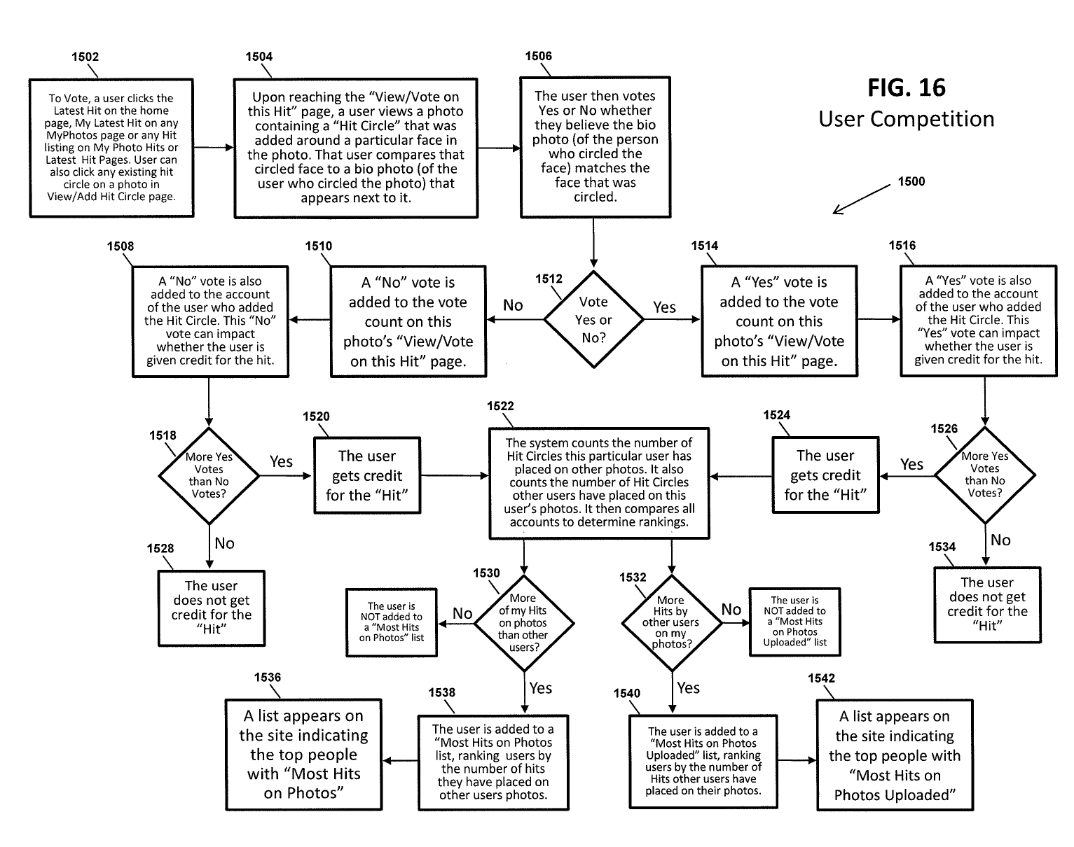

Turning now to scoring, an explanation will be provided of the process of tallying the “Yes” and “No” votes. FIG. 16 depicts a flow chart 1500 of the process performed by the Results processor 26. It should be noted in this regard that even though FIG. 16 is presented in the form of a flow chart, the various boxes of FIG. 16 are also used to depict the software, subroutines, or software modules used to accomplish the steps of the upload process.

In no small part, the benefit of using the website 30 lies in comparing how one user's activity compares to other users. This includes comparing one user's ranking relative to others with regards to the quantity of hit circles they have added to photos (meaning a first user has successfully found his/her face, and circled it, in a number of other user's photos). It also includes a first user's ranking relative to other users with regards to the quantity of hit circles other users have added to the first user's uploaded photos (meaning they successfully found their face in the first user's uploaded photos and added a hit circle). Once calculated, these rankings appear in a part of the home page as well as a Rankings page.

As discussed above, a user 12, 14 clicks 1502 on an appropriate photo to initiate a vote. Upon reaching the page the user may compare a Hit with a bio 1504 to evaluate the validity of the Hit. The user may cast a vote 1506 as a “Yes” or “No” 1512.

A first portion 1510 of the Results processor 26 counts how many “No” votes have been added to the photo while a second portion 1514 counts how many “Yes” votes have been added. The “Yes” and “No” votes are added 1508, 1516 to the account of the user who added the Hit Circle. The “Yes” and “No” votes are compared 1518, 1526 to determine if a user gets credit 1520, 1524. If there are more “Yes” votes than “No” votes, then the user gets credit 1520, 1524. If there are more “No” votes than “Yes” votes, then the user does not get credit 1528, 1534.

The results processor 26 then counts 1522 the number of Hit Circles a particular user has placed on other user's photos. It also counts the number of Hit Circles other users have placed on this particular user's photos. It then compares the results for all accounts to determine rankings. If there are more verified Hits (more “Yes” votes than “No” votes) of the particular user found on other user's photos 1530, then the name of the particular user is added 1538 to a “Most Hits on Photos” ranking based upon the number of verified hits he/she has placed on other user's photos. If there are more verified Hits (more “Yes” votes than “No” votes) by other users on the particular user's photos 1530, then the other users are added 1540 to a “Most Hits on Photos Uploaded” ranking based upon the number of verified hits the other users has placed on the particular user's photos.

In general, the system 10 counts how many Hit Circles a user has added to photos and displays that quantity on the user's My FitC page (shown on the My FitC page) as “My Hits on Photos: XX”.

The system counts the hits that other users have placed on the photo uploads of a particular user and then shows that quantity on the uploading user's My FitC page as “Hits on My Photos: XX”. The system counts the number of Yes and No votes for each hit and shows it on the View/Vote page for each Hit. Voting results information is used to determine the validity of any given hit and, therefore, whether users get credit for the hit. The system compares the quantity of valid hits each user has in two categories, My Hits on Photos and Hits on My Photos, and then ranks all users relative to each other by the quantities of valid hits in these categories.

The system determines whether a hit is valid (and therefore whether to credit it to the users involved). To do this, the system compares the number of Yes votes by users for each hit relative to the number of No votes for a hit.

It does this by subtracting the No votes from the Yes votes for each hit and then using the value generated to indicate valid vs. invalid.

For example, if n>=0 after subtracting 1526, the hit is considered Valid and, as a result, should be credited to the My Hits on Photos of the user who added the hit AND the Hits on My Photos user who uploaded the photo where the hit was added.

For example, a first user adds a hit to a photo. Other users then vote on that hit (View/Vote on this Hit) and the voting results (at a point in time) are 5 “Yes” votes and 4 “No” votes. In this case, a hit credit is added to the My Hits on Photos count on the first user's My FitC page. Also, a hit would be added to the Hits on My Photos count of the user who uploaded the photo.

If n<0, the user is not given credit for the hit. A simple majority of Yes votes over No votes (2 to 1, 100 to 99, etc.) is all that is needed for a hit to be considered valid and credited to the accounts as mentioned above. Conversely, a simple majority of No votes over Yes votes is all that is needed for a hit to be considered invalid and not credited to the accounts as mentioned above. As such, a hit can sequentially become valid and invalid several times, as votes are cast, thereby changing the validity of the vote and possibly the ranking of the users involved.

Once valid hits are determined, the system calculates relative rankings among site users based on the quantity of valid hits each user has in two categories.

Category 1: The system ranks users by the quantity of circles each user has added to photos (My Hits on Photos). The one with the highest hit number in their My Hits on Photos will be at the top, the second highest would be second, and so on down.

Category 2: The system ranks users by the quantity of circles other users have added to a each user's uploaded photos (Hits on My Photos). The one with the highest hit number of hit circles on their uploaded photos will be at the top, the second highest would be second, and so on down.

The system calculates user rankings simply by comparing the quantity of hits in either category described above for each account. For example, if user account “A” has a My Hits on Photos quantity of 5 while another user account “B” has a My Hits on Photos quantity of 3, then account A would be ranked higher than account B in the Most Hits on Photos list. It works the same way with “Hits on My Photos”.

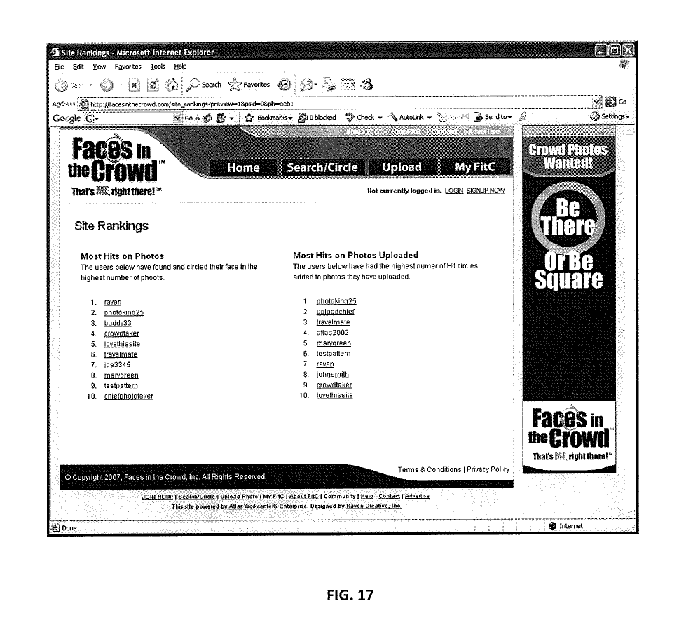

The system generates two ranking lists 1536, 1542 (FIG. 17) from this user ranking information, both of which would appear on the home page (in a minimized format) and on a Rankings page.

The ranking lists are, first, the Most Hits on Photos provided as a clickable list of users (generated by the system) who are ranked according to which users have added the most hit circles on other user's photos. When a usemame in this list is clicked, it goes to the My Photo Hits page of that user.

The second ranking list is the Most Hits on Photos Uploaded provided as a clickable list of users (generated by the system) who are ranked according to which users have had the most hit circles placed by other users on photos they have uploaded. When a username in this list is clicked, it goes to the My Photo Uploads page of that user.

A specific embodiment of a website for displaying and selecting faces has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of sharing photographs among a plurality of users through a website comprising:
a first user of the plurality of users designating a human face among a plurality of human faces in a photograph displayed through the website as being the first user's face; and
at least some other users of the plurality of users voting through the website on whether the designated face is that of the first user.

2. The method of sharing photographs as in claim 1 wherein the step of identifying the human face further comprises placing a circle on the photograph over the human face.

3. The method of sharing photographs as in claim 1 further comprising the first user adding a comment to the designated face.

4. The method of sharing photographs as in claim 1 further comprising the other users clicking on the designated face to display a reference facial image of the first user.

5. The method of sharing photographs as in claim 4 further comprising displaying a set of voting softkeys along with the reference facial image of the first user.

6. The method of sharing photographs as in claim 5 further comprising a user of the other users adding a comment to the referenced facial image.

7. The method of sharing photographs as in claim 1 further comprising a user of the plurality of users uploading the image to the website and appending descriptive information to the image.

8. The method of sharing photographs as in claim 1 further comprising a user of the plurality of users selecting a latest hits softkey to view the image.

9. The method of sharing photographs as in claim 1 further comprising a user of the plurality of users designating the image as being inappropriate subject matter.

10. The method of sharing photographs as in claim 9 further comprising removing the image from the website when the number of inappropriate subject matter designations exceeds a predetermined threshold.

11. An apparatus for sharing photographs among a plurality of users comprising:
a website;
a plurality of photographs displayed through the website;
a human face designated by a first user of the plurality of users among a plurality of human faces in the photograph displayed through the website as being the first user's face; and
a plurality of yes votes and no votes received by the website from at least some other users of the plurality of users voting through the website on whether the designated face is that of the first user.

12. The apparatus for sharing photographs as in claim 11 further comprising a home webpage with an icon for accessing a set of latest uploaded photographs.

13. The apparatus for sharing photographs as in claim 1I1 wherein the home webpage further comprising an icon for accessing a set of latest hits where a hit is a user finding the user's face in a photograph of another user.

14. The apparatus for sharing photographs as in claim 11 wherein the designation further comprises a circle placed around the face of the user.

15. The apparatus for sharing photographs as in claim 11 further comprising a text comment associated with the designation displayed adjacent the designation.

16. An apparatus for sharing photographs among a plurality of users through a website comprising:
a selected photograph of the shared photographs downloaded through the website;
a human face designated within the photograph by a first user of the plurality of users as being an image of the first user; and
a reference photograph of the first user that is downloaded by other users of the plurality of users to determine whether the designated face is the first user.

17. The apparatus for sharing photographs as in claim 16 further comprising a YES softkey and No softkey that allows the other users to vote on whether the designated human face is the first user.

18. The apparatus for sharing photographs as in claim 17 further comprising displaying a ranking of users based upon the votes.

19. The apparatus for sharing photographs as in claim 11 further comprising an inappropriate material softkey that allows the other users to designate the selected photograph as inappropriate subject matter.

20. The apparatus for sharing photographs as in claim 11 further comprising an inappropriate material softkey that allows the other users to designate the reference photograph as inappropriate subject matter.

21. An apparatus for sharing photographs among a plurality of users through a website comprising:
means used by a first user of the plurality of users to designating a human face among a plurality of human faces in a photograph displayed through the website as being the first user's face; and
means used by at least some other users of the plurality of users to vote through the website on whether the designated face is that of the first user.

22. The apparatus for sharing photographs as in claim 21 further comprising a home webpage with a means for searching the shared photographs based upon keywords.

23. An apparatus for sharing photographs among a plurality of users through a website comprising:
a photograph containing a plurality of human faces within the photograph downloaded through the website;
a human face designated with a circle around the face within the photograph by a first user of the plurality of users as being an image of the first user; and
a reference photograph of the first user that is downloaded by other users of the plurality of users to determine whether the designated face is the first user; and
a voting webpage that allows the other users to vote on whether the human face is an image of the first user.

24. The apparatus for sharing photographs as in claim 23 wherein the designation further comprises a circle disposed around the face.

25. The apparatus for sharing photographs as in claim 24 further comprising a text box disposed adjacent the circle.
